(19) United States
(12) Patent Application Publication
(10) Pub. No.: US 2008/0247278 A1
(43) Pub. Date: Oct. 9, 2008

(54) PROGRAMMABLE WATCH WINDER

(75) Inventors: Jason Walker, Lenexa, KS (US); Biao Fu, Overland Park, KS (US)

Correspondence Address: ERICKSON & KLEYPAS, L.L.C., 800 W. 47TH STREET, SUITE 401, KANSAS CITY, MO, 64112, US

(73) Assignee: Jason Walker, Lenexa, KS (US)

(21) Appl. No.: 12/044,929

(22) Filed: Mar. 7, 2008

Related U.S. Application Data
(60) Provisional application No. 60/893,376, filed on Mar. 7, 2007.

(51) Int. Cl. G04B 5/00

(52) U.S. Cl. 368/206

(57) ABSTRACT

An automatic watch winder that is user-programmable via USB (Universal Serial Bus) and/or wireless IrDA (Infrared), IEEE 802.11, or IEEE 802.15 connections to a computer, such as a laptop or notebook computer. The watch winder also includes a user programmable, high intensity LED illuminator used to charge the luminous material on a watch

### CROSS REFERENCE TO RELATED APPLICATION

This application claims priority from pending provisional patent application No. 60/893,376 filed on Mar. 7, 2007.

### BACKGROUND OF THE INVENTION

1. Field of the Invention

The present invention relates generally to watch winders for winding automatic (self-winding) watches and more particularly to a programmable watch winder that is electronically adjustable to optimize winding motions according to particular watch manufacturer specifications.

2. Description of the Related Art

Automatic watches are wound by the motion of internal components of the watch body when the watch body is moved in typical use upon a wearer's arm. Therefore, automatic watches do not require manual winding or battery power. A small counter-weight or balance wheel that has incorporated the counter-weight system, inside the watch rotates due to watch movement while the watch is worn. As it moves, the counter-weight turns a rotor that engages the watch's winding mechanism. Automatic watches are a type of mechanical watch and, as with other mechanical watches, they should be kept running to avoid congealment of internal lubricant that can occur if a watch's internal movements stand idle for extended periods of time. Since a fully wound watch may only run for two or three days without further winding, automatic watch winders have been used to simulate the motions of the watch wearer, causing the watch to wind even while not worn. Existing watch winders only allow a small number of pre-set selections, however, and lack user programmability for complete customization of watch winder functions which are needed to encompass all different watch movements, past, present, and future, within a single watch winder design. Existing watch winder design has typically been reactive in nature, only supporting particular watch movements after introduction to the market.

It would be advantageous, therefore, for a watch winder to include means for adjusting the motion of the winder and the duration of a winding session according to the specific winding requirements of a particular watch.

### BRIEF SUMMARY OF THE INVENTION

An automatic watch winder includes a microprocessor that is programmed by the end user remotely, through custom software run on a computer or computer processor device (e.g. PDA, mini-computer, cellular phone), or via a remote control, connected to the winder via USB (Universal Serial Bus), IrDA (Infrared), wireless local area network (WLAN) communication (e.g. various 802.11 and/or WIFI protocols), wireless communication technologies according to the IEEE 802.15 specifications and marketed Linder the Bluetooth® or Zigbee® marks (IEEE 802.15.1 and IEEE 802.15.4 specification, respectively), other wireless data communication standards, or other operative means, to provide specific, tailored winding scenarios for all automatic watches/movements. The winder is capable of providing user specified: turns per day (TPD), direction of rotation, elapsed time of rotation, as well as complete control of a high intensity LED light source used for charging the luminous material often provided on a watch face to improve visibility in low light conditions. The winder provides for the ability to upgrade these selections via associated winder software. The winder has a display that shows the user the number of turns that have been completed, the elapsed time that the winder has been running, and the current time of day. The winder rotates an automatic watch around the watch's axis, thereby winding the automatic movement inside the watch, and keeping the watch running and fully charged.

The winder microprocessor may be connected to a personal computer (PC) or other programmable device and programmed by the end user to generate custom winder rotation according to any selected watch movement. Connection between the programmable device and the winder may be by any operative method such as USB, via an integrated IrDA port, WLAN communication, Bluetooth®, or Zigbee® modules located on the winder. This allows the winder to receive its program from any IrDA source wirelessly (such as a PDA, cellular phone, universal remote control, etc) as well as from any WLAN, Bluetooth®, or Zigbee® wireless source.

Control of LED light used to charge the luminous material on watch faces is also completely user programmable via the software and PC-to-winder data communication means mentioned above. Winder software may be used to control the LED brightness, duration of time that LED is on or off, as well as being able to create a specific, repetitive “onloff” interval that is timed or set to run indefinitely (i.e. 1 minute on, 5 minutes off, 1 minute on, 5 minutes off, etc.). This allows the user to appropriately charge the luminous material on the user's particular watch, causing the luminous material to glow brightly for many hours afterwards, thereby enhancing the readability of the watch face indicia in darkness, or during low light conditions.

Watch winders according to the present invention are proactive in design, and able to adjust to wide variations in movements through associated software in communication with an on-board winder microprocessor linked to the PC or other programming device running the winder programming software. This is a substantial improvement over the prior art because it allows the winder to adapt to new watch specifications, even before the movement is defined by the manufacturer. The winder may utilize a USB connection to a PC or equivalent device to not only power the winder, but also to power a high intensity LED array that is used to charge the luminous material on a watch. The USB connection or any of the above mentioned wireless connections may be used to program all winder parameters, as well as relay real-time data between the winder and the programming device in a bi-directional communication mode.

Other advantages of the invention will become apparent from the following description taken in connection with the accompanying drawings, wherein is set forth by way of illustration and example an embodiment of the present invention.

### BRIEF DESCRIPTION OF THE SEVERAL VIEWS OF THE DRAWINGS

FIG. 1 is diagram of a watch winder to be connected to a laptop computer.

FIG. 2 is a diagram showing selected, primary, watch winder components.

FIG. 3 is a side elevational diagram of a watch winder with the wall of the watch winder nearest the viewer cut-away or removed to show internal components in place.

FIG. 4a is a cross sectional diagram of a pillow, inner cup and outer cup showing a the motor and gearbox mounted to the underside of the outer cup.

FIG. 4b is a front, isometric view of a watch winder pillow.

FIG. 4c is a front, isometric view of the pillow with a watch installed thereon.

FIG. 5a is a front view of a watch winder pedestal showing a watch, in phantom lines, mounted upon the pillow.

FIG. 5b is a side and slightly rearward view of the pedestal of FIG. 5a

FIG. 5c is a side view of the pedestal of FIG. 5a rotated 90 degrees about the pedestal axis of rotation.

FIG. 6 is a front elevational view of an embodiment of a watch winder including four winder heads and illustrating a watch mounted upon each of two winder pedestals.

FIG. 7 is a schematic of watch winder electrical circuitry.

FIG. 8 is a main flow chart showing processes of the watch winder programming.

FIG. 9 is a USB and IrDA read/write flow chart.

FIG. 10 is a screenshot showing a watch winder software application GUI.

FIG. 11 is a screenshot showing an alternative watch winder software application GUI.

FIG. 12 is a flowchart showing processes of the watch winder software application running on a PC.

FIG. 13 is a diagrammatical view of the watch winder circuit board (PCBA).

### DETAILED DESCRIPTION OF THE INVENTION

As required, a detailed embodiment of the present invention is disclosed herein; however, it is to be understood that the disclosed embodiment is merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Hardware Components

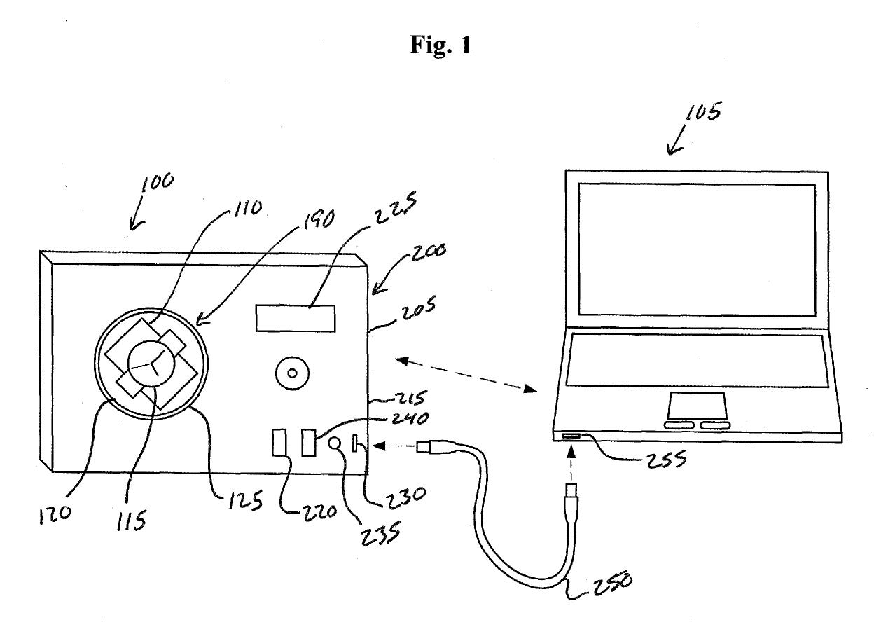

Referring now to FIGS. 1 through 13, and particularly to FIG. 1, there is shown a watch winder 100 to be connected to a laptop personal computer (PC) 105, so that the winder 100 may receive winding parameters from the specialized winder software resident on the PC 105 and so that the winder may transmit data back to the PC 105 such as the total time elapsed, and number turns or rotations completed, during a winding routine.

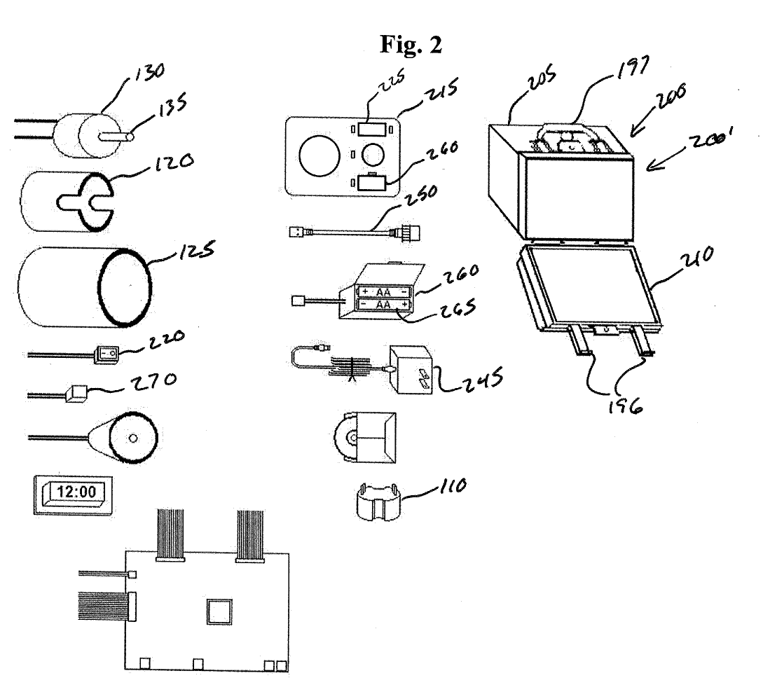

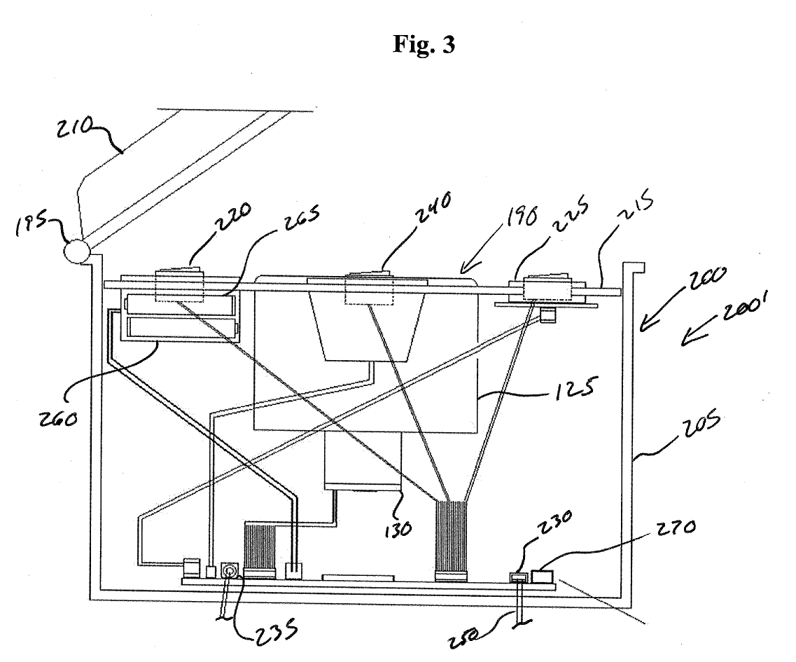

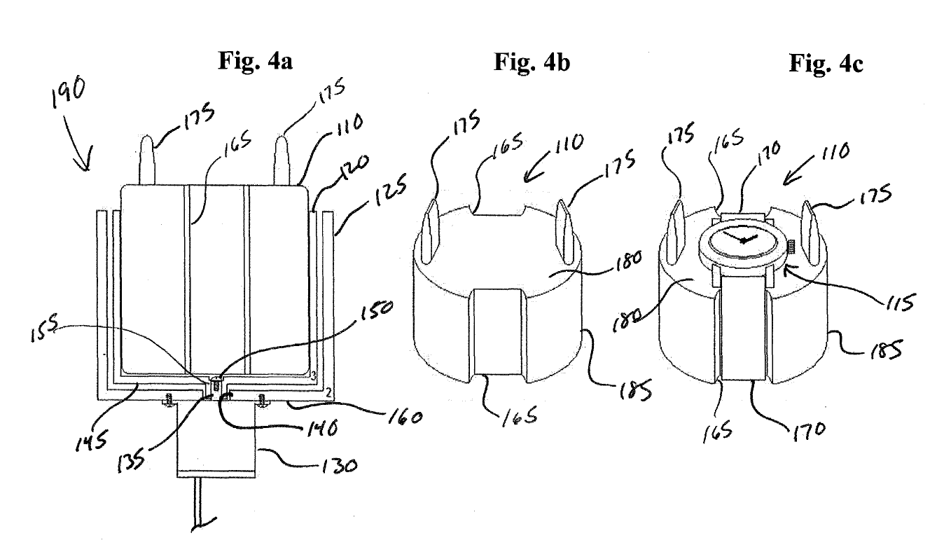

The watch winder 100 may include the following hardware components illustrated separately in FIGS. 2, 4a, 4b and 4c and shown assembled in FIG. 3. It should be appreciated that many of the mechanical aspects of a watch winder 100, and the fabrication and assembly thereof, are known in the prior art, the present invention being directed to several improvements and particularly to improvements yielding a programmable watch winder 100. Components of a watch winder 100 may typically include a pillow 110 comprising foam or other material unlikely to scratch or otherwise mar the surfaces of a watch 115 mounted upon the pillow 110 for winding, an inner watch cup 120 for holding the pillow 110 once a watch 115 for winding is installed thereon, and an outer cup 125 for providing a support structure for the inner cup 120. A motor assembly 130 comprising a DC motor and associated gearbox for reducing the speed imparted to a shaft 135 are connected via the shaft 135 through an aperture 140 in the outer cup 125 to the bottom surface 145 of the inner cup 120. Typically, the end of the shaft 135 proximate the bottom surface 145 includes a threaded bore (not shown). A screw 150 is passed through an aperture 155 in the bottom surface 145 of the inner cup 120 and then through the larger aperture 140 in the outer cup 125 to threadably engage the bore of the shaft 135.

FIG. 4a illustrates in diagrammatic cross section a pillow 110 mounted inside an inner cup 120 and held therein by friction between the outer surface of the pillow 110 and the inner surface of the inner cup 120, and the inner cup 120 mounted within the outer cup 125 and held there by a screw 150 attached to the shaft 135 of a motor assembly 130 mounted to the bottom surface 160 of the outer cup 125. FIG. 4b shows an embodiment of a pillow 110 including side channels 165 for accepting the band 170 of a wrist watch 115 and ears 175 for grasping by the user when pulling on the pillow 110 to remove the pillow 110 and watch 115 when winding is complete. FIG. 4c shows the pillow 110 of 4b with an automatic wrist watch 115 mounted on the pillow 110 by strapping the watch band 170 around the top surface 180 sides 185 and bottom surface (not shown) of the pillow 110.

The pillow 110, inner cup 120, outer cup 125, and motor assembly 130 form a winder head 190. The winder head 190 and other winder components are housed within a winder box or housing 200. The winder housing 200 comprises a main body 205 having, generally, the shape of an open-sided cube, and a cover or door 210 sized to close the open portion of the main body 205 so that the housing 200 forms an enclosure protecting the internal components from dust, moisture, etc. The open side of the main body 205 may generally be referred to as the front side. A faceplate 215 covers the front side of the winder 100 and typically includes at least one winder head 190, a power switch 220 for turning the winder 100 on or off, an LED display 225, a USB port/receptacle 230, an AC power jack 235, and a switch 240 for turning an LED charging lamp on or off, see FIG. 1.

An electrical adapter 245 with AC to DC transformer may be plugged into the AC power jack 235 to provide DC current to the winder electronics. Alternatively, the winder 100 may be powered through the USB port 230 by plugging one end of a USB cable 250 into the USB port 230 on the winder and the other end of the cable 250 into the USB port 255 of a PC 105. The winder 100 may also be provided with a battery compartment 260 for receiving batteries 265 if batteries are used to power the winder 100.

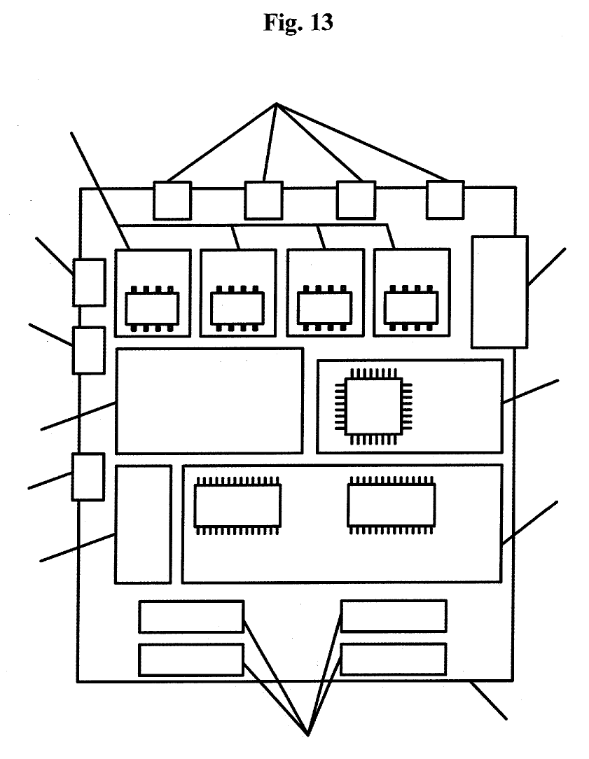

Data communications between the winder 100 and the PC 105 may be transmitted via the USB cable 250 or, and particularly if the electrical adapter 245 is used instead of the USB cable 250 to power the winder 100, data may be transmitted to and from the winder 100 via an IrDa (infrared light) port 270 or wireless radio modules (see FIG. 13).

One embodiment of a housing 200, see FIGS. 2 and 3, is designed in the form of a carrying case 200′ with a door 210 secured to the main body 205 via hinges 195 and including latches 196 and a handle 197. To protect the components of the winder 100 housed within the housing 200, the housing 200 is preferably formed of resilient material such as wood, aluminum, steel or plastic. The front cover or door 210 may also comprise such resilient materials.

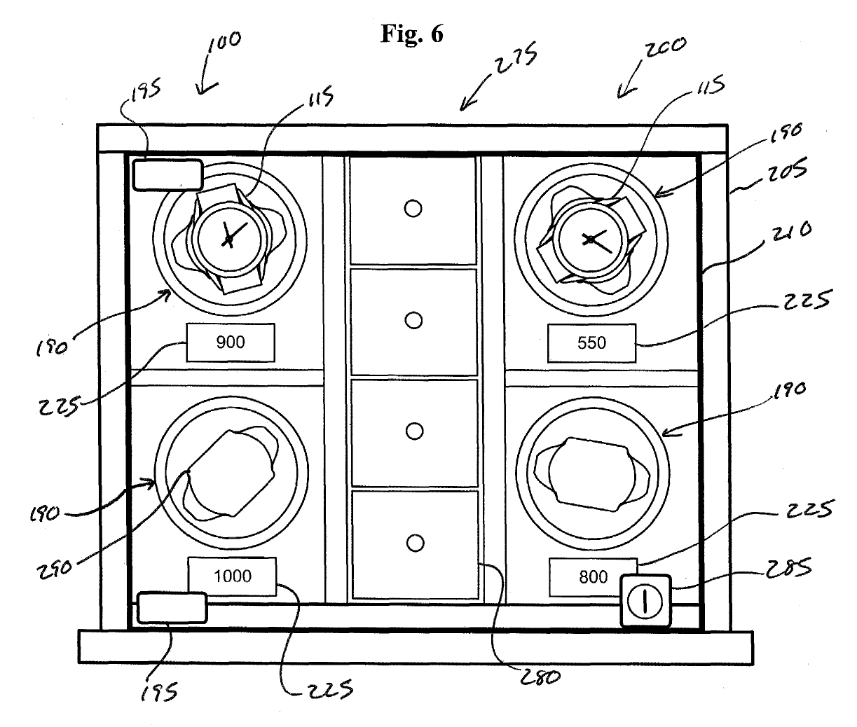

The housing 200 may also take the form of a cabinet 275 as shown FIG. 6. Drawers 280 may be included inside the cabinet 275 for storing small items and the winder housing 200 may therefore serve an auxiliary function as a jewelry box or a storage container for keepsakes. The door 210 is attached to the main body 205 along one side by hinges 195 and includes a means for retaining the door 210 in a closed position. A hasp or snap that engages a cooperating element on the main body 205 may be used. The means for retaining the door 210 in a closed position may include a keyed lock 285. For aesthetic purposes, the cabinet 275 is preferably constructed of wood or wood laminate but may comprise any suitable resilient material. The door 210 of the cabinet 275 typically comprises glass or high clarity acrylic plastic to allow ready viewing of the front portions of the winder heads 190 and associated watches 115 mounted thereon.

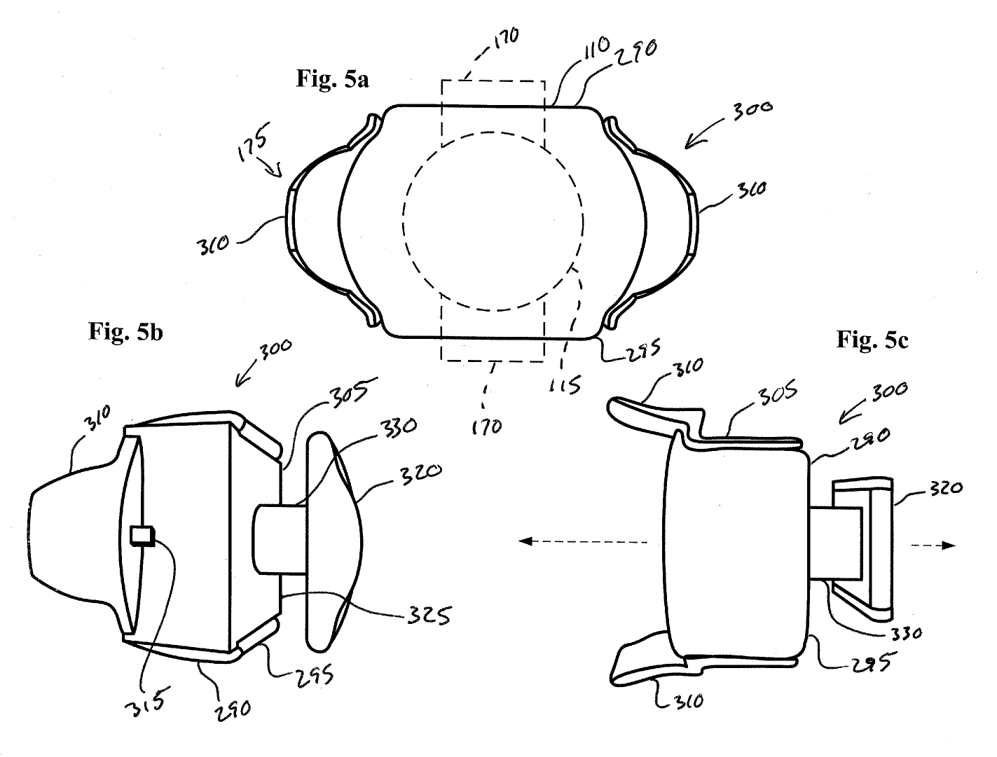

As shown in FIGS. 5a, 5b, 5c and 6, a winder head 190 may include an alternative embodiment of a watch pillow 110. This pillow 110 embodiment will be specifically referenced herein as pillow 290. Pillow 290 is mounted on a pedestal 300 that is housed within an inner watch cup 120. An automatic winding watch 115 is mounted on the watch pillow 290 prior to activation of the winder 100 and initiating a watch winding cycle.

The pedestal 300 components are typically molded from high density plastic. The pillow 290 is typically formed from a U-shaped plastic faceplate 295, the upper portion of which is covered with cloth, leather, vinyl, or other suitable material selected to provide a non-scratching surface against which the watch 115 may lie.

The faceplate 295 snaps onto the front portion of a backplate 305. The backplate 305 includes upwardly projecting protective ears 175, denoted more specifically as 310, which the user can grip during removal and insertion of the pedestal 300 from the inner watch cup 120. Locking tabs 315 on opposing sides of the backplate 305 snap into matching holes (not shown) in the inner cup 120. A spring-biased shoe 320 is attached to the back surface 325 of the backplate 305. The shoe 320 is a generally rectangular plastic element that is typically covered on at least the back surface by the same material used to cover the pillow 290 (e.g. cloth, leather, or vinyl). A column 330 projecting from the front surface of the shoe 320 includes a spring (not shown) projecting from the front portion of the column 330. The spring passes through an aperture in the back surface 325 of the backplate 305 to engage the back surface of the faceplate 295. The shoe 320 and column 330 are sized so that when they are engaged with the backplate 305 and faceplate 295, the distance from the front surface of the pillow 290 to the back surface of the shoe 320 exceeds the typical diameter of most wrist watch bands 170. When a watch 115 is installed upon the pedestal 300, the main body of the watch 115 is placed upon the front surface of the pillow 290 and the opposing portion of the wrist band 170 of the watch 115 is looped over the back surface of the shoe 320, thereby squeezing the shoe 320 toward the backplate 305 and compressing the spring which then exerts an outwardly biased force, holding the watch 115 in position upon the pedestal 300.

The inner watch cup 120 holds the watch pillow 290 tightly in place by engaging the aforementioned tabs 315 on the backplate 305. This allows the watch pillow 290 (bearing an automatic winding watch 115) to rotate in unison with the inner watch cup 120, thereby rotating the watch 115 attached to the watch pillow 290 around the watch's axis. If the speed and duration of rotation have been correctly selected by the user, the winder 100 thereby provides rotation sufficient to cause the winding mechanism within the watch to wind the watch 115.

Because the inner watch cup 120 is mounted within an outer watch cup 125, the outer watch cup 125 forms a structure to enclose and protect the inner watch cup 120 from damage during rotation. The inner watch cup 120 is attached to a winder motor assembly 130 (typically through an aperture 140 in the back surface 160 of the outer watch cup 125) for imparting rotational movement from the shaft 135 to the inner watch cup 120. The winder motor is a two-leaded DC voltage motor provided with a speed reduction drive assembly. The speed reduction drive assembly takes the DC motor's relatively high speed of rotation and lowers it through transmitting rotational movement through a series of intermeshed gears selected to reduce rotational speed to a desired rate of rotations per minute. This allows the inner watch cup, which houses the automatic watch that is being wound, to spin at a much slower rate. The outer watch cup 125, the inner watch cup 120, and the winder motor assembly 130, when assembled together, are referred to as the winder head 190. DC switches are provided for use by the end user to turn on and off specific functions of the watch winder. A lume charger 335 comprises a high intensity LED light source that is used to charge the luminous material on a watch 115, when the watch is held on a watch pedestal 300 proximate this light source.

The winder 100 is connected to a personal computer (PC), for example (or other programming device) so that the winder may receive programming instructions and/or parameters from the programming device. The connection to the winder may be via USB (Universal Serial Bus) cable, IrDA (Infrared), WLAN communication including 802.11 and/or WIFI protocols, wireless communication technologies marketed under the Bluetooth® or Zigbee® marks, or other equivalent or otherwise effective means. In one embodiment, the winder is connected to a laptop PC via USB cable. One end of the USB cable attaches to a USB port on the PC, and the other end of the cable attaches to a USB port on the winder to receive instructions from software running on the PC. The winder may also contain a WLAN wireless module and/or a Bluetooth® or Zigbee® wireless transceiver. These wireless technologies allow the winder to both transmit and receive real-time data packets to and from the PC using radio signals in the 100 MHz to 6.5 GHz frequency range.

The Printed Circuit Board Assembly (PCBA) of the winder receives instructions from the winder software loaded on the PC and controls the hardware of the winder. The PCBA holds the microprocessor, the USB interface module, the IrDA interface module, WLAN module, Bluetooth® or Zigbee® transceivers, the motor driver(s), the display driver(s), the LED lume charger driver, the DC switch(es) interface, the AC wall mount power interface, and the AA battery power interface. The microprocessor located on the PCBA communicates via any of the above-disclosed means to the PC.

An LED display outputs information from the microprocessor, for the end user to view, such as Turns Completed, Elapsed Time Running, Time of Day, etc. A battery box contains the removable AA Battery Pack, which contains replaceable AA batteries. The AA battery pack supplies the necessary DC voltage to the winder when the winder is not connected to a USB Port on a PC, and also not connected to an AC wall mount universal power adapter. The AC adapter is used to provide power to the winder. The adapter is preferably a universal wall mount power supply that takes AC voltage and converts it into DC voltage that is used to power the winder, when the winder is not drawing power from a USB Port, or drawing power from the battery pack. A winder faceplate holds the winder head, the display(s), the lume charger, the battery box and “AA” battery back, and the DC Switch(es).

Electrical and Software Components

With further reference to the figures, the watch winder includes the following electrical and software components. The watch winder typically includes a CPU with a USB port, IrDA port, WLAN module, and Bluetooth and/or Zigbee transceiver modules, 1 to 4 motor drivers and corresponding motors and displays, and a LED charger.

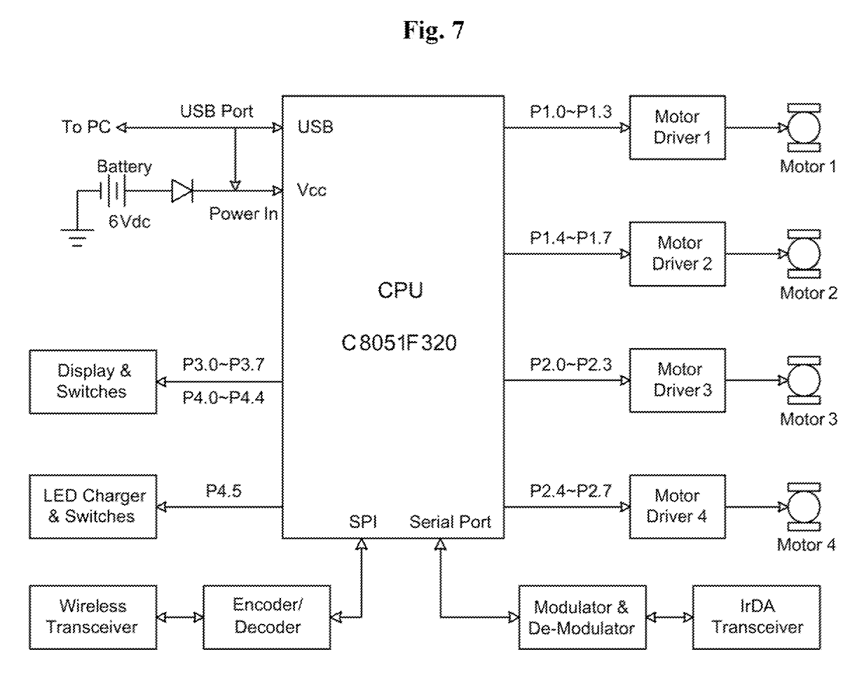

A diagram of the winder PCBA is shown in FIG. 7 illustrating the CPU connected to one or more wireless transceivers and encoder/decoder circuits for relaying data and instructions between the PC and the CPU. Similarly, an IrDa Transceiver and modulator/demodulator are connected to the CPU as an alternative means for relaying such data and instructions. The IrDA transceiver provides for wireless communication, via infrared signal, with any IrDA-capable programming device, in particular handheld devices such as: PDA, cell phone, and universal remote controller. A USB port is further provided as another alternative means for relaying such data and instructions. The wireless transceiver, IrDa transceiver and USB port each provide means for the watch winder to communicate with a PC or other programming device and perform commands sent by the programming device.

In addition to providing a communication means, the USB port provides electrical power (e.g. from a PC) to the watch winder. Other circuits associated with the PCBA draw power from either the USB port, one or more batteries or via an AC adapter.

The CPU typically controls 1 to 4 winder motors. The CPU reads the working parameters from the integral CPU flash memory and causes each of the motors run according to the parameters specified for that winder head by the programming device, namely, the specified motor speed, direction (clockwise, counter-clockwise, or with periodic direction change), and specified total time duration or number of turns. Each motor has its own independent setting specified by software on the programming device and transmitted and stored on the CPU. The motors are controlled by the CPU through motor driver circuits on the PCBA.

LED displays are located on the front panel of the winder, one proximate each winder head. The LED displays show the turns completed and time elapsed for each winder head. The PCBA includes LED display driver circuits and connectors for connecting wire leads from each display to the PCBA and driver circuits.

The LED illuminator or lume lamp is also located on the front panel of the winder and is used to charge the luminous material typically present on the faces of the watches being wound. A LED illuminator or charger circuit, for providing power to the lamp and for switching the lamp on or off according to programming received from the programming device, is located on the PCBA.

Winder software is loaded onto a PC or other programming device that is used by the end user to control the winder functions. When the software is launched, the end user can control all functions of the winder via the software GUI (Graphical User Interface). Winder Selection, TPD Rate, Direction of Rotation, Time ON/OFF of the Lume Charger, Elapsed Time Shown, Data Write, Help, and Reset can all be controlled by the user via this software. The end user can thereby control all the functions of winder by communicating directly with the winder via USB connection, wirelessly, or via the IrDA port.

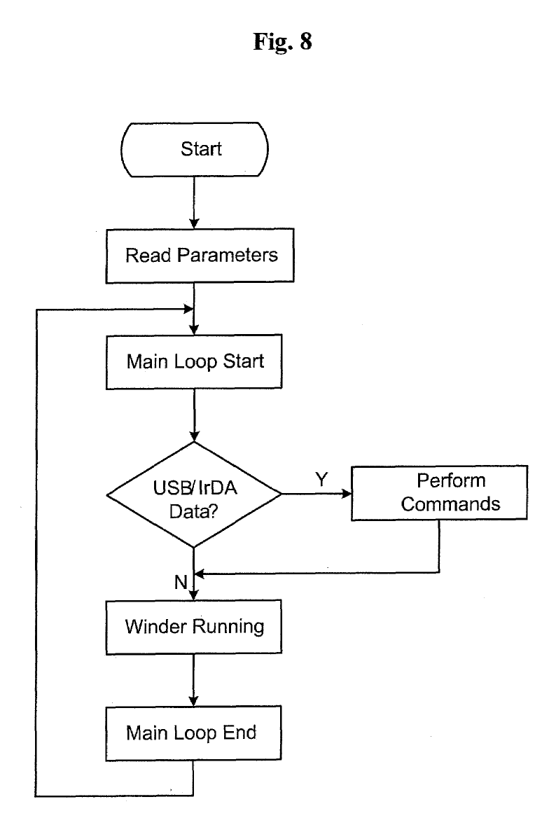

A watch winder software main flow chart is shown in FIG. 8. The CPU reads the working parameters from flash memory for a winder motor and then enters the thread loop. In the loop, the CPU monitors USB, IrDA and wireless communication ports, and controls the winder motor. If a communication port receives a command, the CPU performs corresponding operations, which include parameter writing, data inquiring, and resetting.

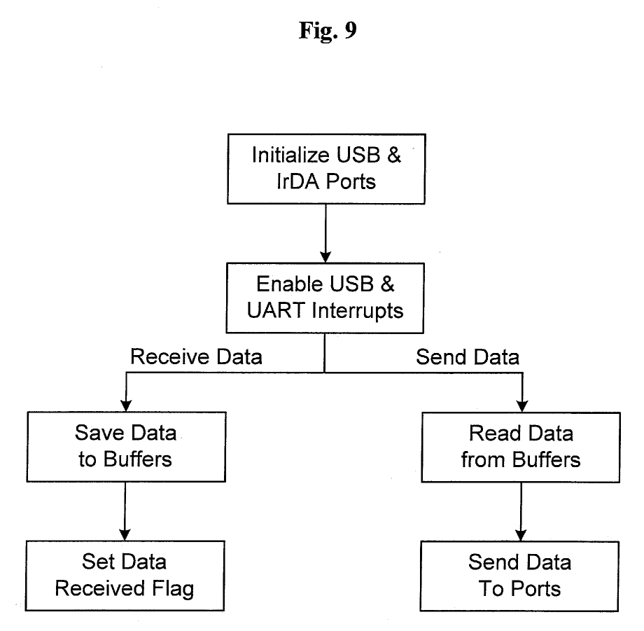

A communication port read/write flow chart is shown in FIG. 9. The codes work in interrupt mode. Once a communication port receives data, they save the data into the receiving buffers and then set a data received flag to the main thread of the program. When sending data, the communication ports read data from the sending buffers and the data is transmitted to the ports.

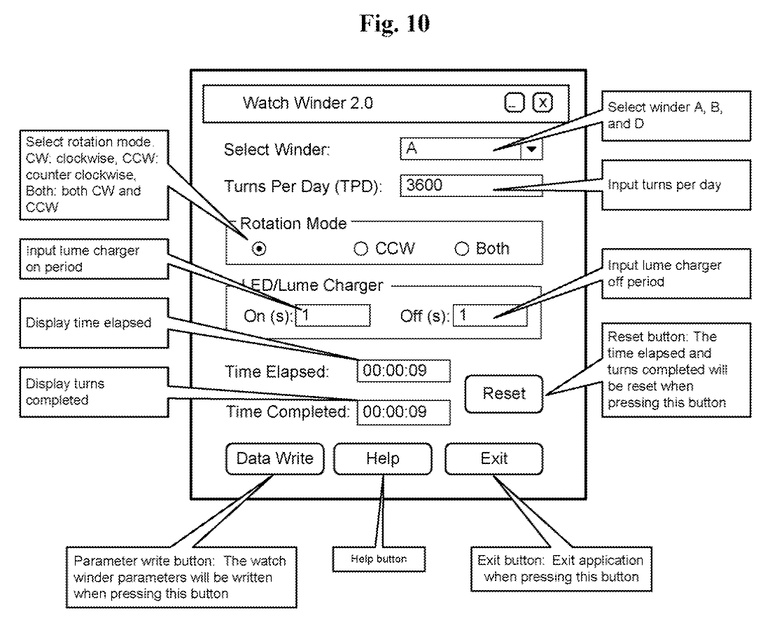

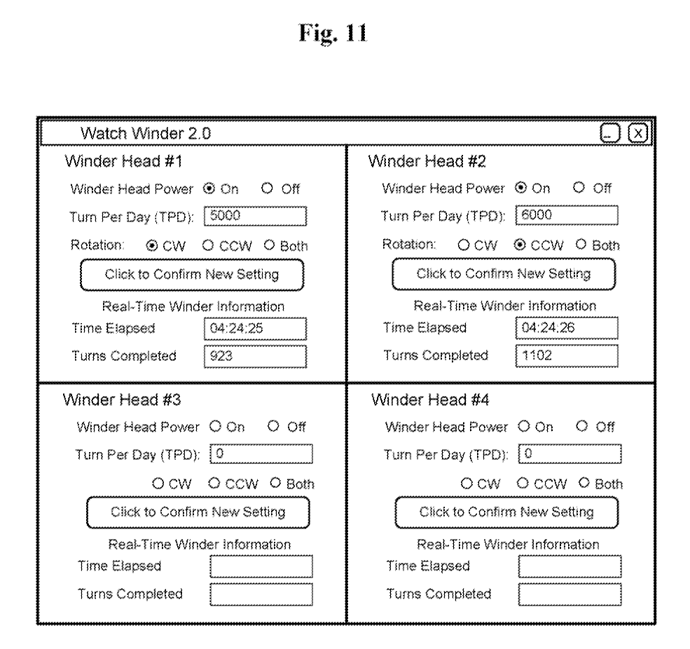

An example of the software Graphical User Interface (GUI) and its associated functionality is shown in FIG. 10. An example of an alternative GUI is shown in FIG. 11.

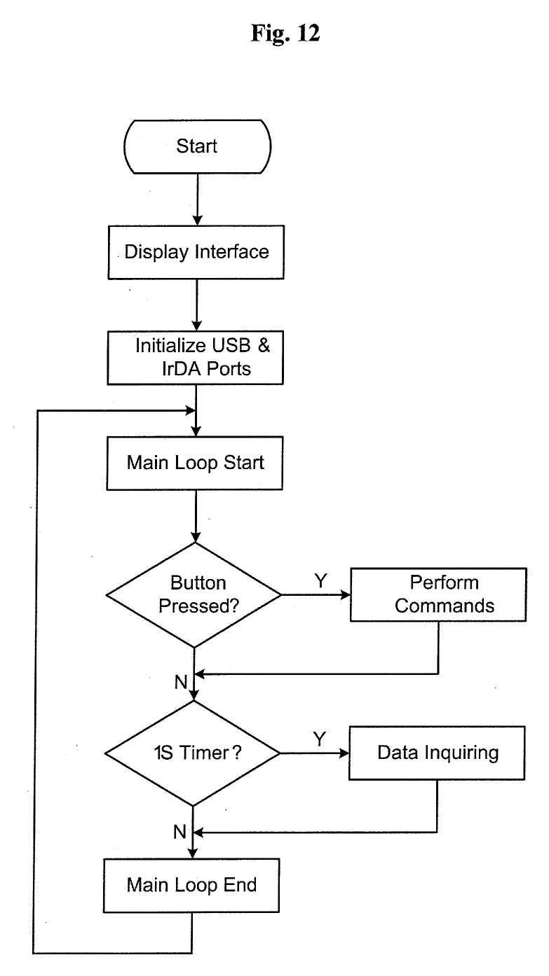

The PC software flow chart is shown in FIG. 12. The application displays the GUI and initializes communication (e.g. USB, wireless) ports first, and then enters the main thread loop. In the loop, it responds to the function buttons pressed and collects the data from the watch winder once per second.

A winder according to the present invention and the embodiments described herein may be used according to the following steps of:
1. Installing watch winder software on a software-compatible programming device such as a PC, PDA, hand-held mini-computer, or cellular telephone capable of storing and running the watch winder program.
2. Plugging the USB cable into a USB receptacle on the winder or, alternatively, enabling wireless modules on the winder.
3. Plugging the USB cable, if used, into the programming device USB receptacle. The following instructions will assume that the programming device is a PC.
   a) The PC will automatically recognize Winder, and will show new USB hardware, or new wireless device, installed and ready to use. The winder will begin operation, using the factory preset program or the program last transmitted to the winder by a user.
4. Launching the watch winder software by clicking on the watch winder icon located on the PC screen.
   a) The software will automatically detect the number of winder heads provided on the winder attached to the PC.
5. Selecting the winder head, among the winder heads indicated on the software GUI, for which parameters are to be entered or changed.
6. If the GUI generally corresponds to the illustration in FIG. 10:
   a) Selecting a winder head from the drop down “Select Winder” menu; or If the GUI generally corresponds to the illustration in FIG. 11:
   b) Selecting a winder head by using a mouse or other pointing device to select a text box or radio button within the portion of the GUI apportioned for displaying the selected winder head information.
7. Entering the desired turns or rotations per day rate in “Turns Per Day (TPD)” box.
8. Selecting the rotation mode by “Rotation Mode” selecting the appropriate radio button. As shown in both FIGS. 10 and 11, “CW” denotes clockwise rotation of the winder, “CCW” denotes counter-clockwise rotation of the winder, and “Both” denotes both clockwise and counter-clockwise rotation of the winder.
9. Programming the LED/Lume, if provided, by entering the LED/Lume charging on time and off time and selecting charger brightness. If the winder is provided with an LED/Lume illuminator, the following steps will allow programming of the LED/Lume parameters:
   a) Enter LED/Lume charging ON time (in seconds) in “On (s)” box. This specifies the amount of time (in seconds) that the LED/Lume Charger will remain ON, before turning OFF.
   b) Enter LED/Lume charging OFF time (in seconds) in “Off (s)” box. This specifies the amount of time the LED/Lume Charger will remain OFF, before turning ON again.
   c) Enter LED/Lume charger brightness, being a number from 1-5, (1 being dimmest, 5 being brightest).
10. Clicking the “Data Write” (FIG. 10) or “Click to Confirm New Setting” (FIG. 11) button to transmit the selected parameters to the winder.
11. Following the above steps to complete programming of the winder, the “Turns Complete” and “Time Elapsed” displays on the GUI will reset, and the winder MCU will begin performing the steps of FIG. 8 in accordance with the parameters received from the PC-resident software.
12. Alterations to the winder parameters, may be made by opening watch winder software on the PC by clicking on the desktop icon, changing the data as desired, and clicking the “Data Write” or “Click to Confirm New Setting” button. The new parameters will be transmitted and stored in the winder MCU and the winder will rotate the pedestals in the winder heads according to the new parameters.

A winder according to the present invention and the embodiments described herein may also be used following the steps below.
1. Connect an AC power adapter or connect a USB cable to the winder first. Turn on the power switch, the microcontroller (MCU, also referred to herein as CPU) starts to run its program.
2. The MCU initializes the USB port of the winder and creates a USB connection if connected with a computer, or suspends the connection if there is no connection with the PC.
3. The MCU initializes the wireless module or IrDA module of the winder and creates a TCP/IP or Bluetooth wireless connection.
4. The MCU reads the presence of a combination of two resistors, R14 and R15, on the PCBA to determine the number of winder heads.

R14 (Not present) and R15 (Not present)—4 winder heads

R14 (Present) and R15 (Not present)—3 winder heads

R14 (Not present) and R15 (Present)—2 winder heads

R14 (Present) and R15 (Present)—1 winder heads
5. The MCU reads winder working parameters from the flash memory located inside the MCU. There are four group parameters associated with the four winder heads, which are stored in the flash memory of the MCU. The parameters are as follows:
   a. Head enabled/disenabled. O-disenabled, 1-enabled
   b. One turn period in second. Default setting is 10 seconds.
   c. Turning mode: clockwise, counter clockwise, or both directions.
   d. Turns per day (range from 15 to 6000).
6. The program loop shown in FIG. 8 is initiated within the MCU causing the following steps to occur:
   a. The four winder heads rotate according to their working parameters which include:
      i. Head enabled/disenable. If the head is enabled, it will be powered, otherwise, it won't be powered.
      ii. One rotation per 10 seconds. Motor turns for 10 seconds to finish one turn of the inner cup and then stops for a rest period lasting the number of seconds calculated according to the selected number of turns per day parameter. The length of a rest period may be calculated as follows: Assuming 86,400 seconds in one day (60 seconds in one minute X 60 minutes in one hour X 24 hours in one day), divide 86,400 by the desired number of revolutions per day, for example, 800. The product is 108 seconds which defines the length of a revolution period. Subtract the length of time of one revolution, 10 seconds, to yield 98 seconds, the length of a rest period between revolutions if the winder is operating at 800 revolutions per day.
      iii. Turning modes: clockwise, counter clockwise, and both. Clockwise—causes the inner cup to turn in a clockwise direction; Counter clockwise—causes the inner cup to turn in a counter clockwise direction; Both—causes the inner cup to turn in a clockwise direction for one complete rotation of the inner cup and then in counter clockwise direction for one complete rotation of the inner cup, and then alternating thereafter.
      iv. Turns per day. This parameter determines the number of rotations to occur within a day and is used to calculate the stop or rest period of the selected winder head.
   b. If the USB cable is unplugged from the PC, the MCU of the winder suspends the USB connection (assuming the winder still works with an AC adapter). If the USB cable is re-connected to a computer USB port, the MCU resumes the USB connection.
   c. MCU checks interrupt sources of the USB port and serial port (used for wireless module or IrDA module). If interrupt flag(s), the MCU performs corresponding interrupt service subroutine.
      i. Reads the command data from corresponding devices. The commands are: Parameter writing command, Head enabled/disenabled command, and Working data requiring command.
      ii. Performs the following commands:
         (1). Parameter writing command. Receives the parameters sent from PC, and then store the parameters into the MCU flash memory.
         (2). Head enabled/disenabled command. Enable or disable the winder head and store this parameter into the MCU flash memory.
         (3). Working data requiring command. PC requests working data from winder. The winder sends data (turns completed and time elapsed) to PC.
      iii. USB and serial communication ports stand-by
7. The main program continues at the loop beginning.

It is to be understood that while certain forms of this invention have been illustrated and described, it is not limited thereto except insofar as such limitations are included in the following claims and allowable equivalents thereof.

Having thus described the invention, what is claimed as new and desired to be secured by Letters Patent is as follows:

1. A watch winder comprising;
a housing containing a pedestal, said pedestal having an axis of rotation, said pedestal including means for securing a wristwatch thereon;
means for rotating said pedestal about said axis; and
computer means for controlling the rotation of said pedestal.

2. The watch winder of claim 1 wherein said computer means comprises a multiprocessor mounted within said housing.

3. The watch winder of claim 2 wherein said multiprocessor is receives parametric data in the form of electrical signals from a remote programming device.

4. The watch winder of claim 3 further including means for transmitting electrical signals between said multiprocessor and said programming device.

5. The watch winder of claim 4 wherein said means for transmitting comprises a USB connection between said multiprocessor and said programming device.

6. The watch winder of claim 5 wherein said programming device comprises a personal computer.

7. The watch winder of claim 4 wherein said means for transmitting comprises radio signals sent and received to and from said multiprocessor and said programming device.

8. The watch winder of claim 4 wherein said means for transmitting comprises infrared light signals sent and received to and from said multiprocessor and said programming device.

9. The watch winder of claim 7 wherein said radio signals are transmitted and received between said multiprocessor and said programming device according to a wireless data communication standard selected from the group consisting of IEEE 802.11, IEEE 802.15, IEEE 802.15.1, and IEEE 802.15.4.

10. The watch winder of claim 1 further comprising software resident on said computer for receiving winder parameters from a user.
